(19) United States
(12) Patent Application Publication
(10) Pub. No.: US 2026/0312180 A1
(43) Pub. Date: Oct. 8, 2026

(54) BATTERY PACK THERMAL BARRIERS WITH INTERLOCKING INTERFACES

(71) Applicant: Ford Global Technologies, LLC, Dearborn, MI (US)

(72) Inventor: John Peter Bilezikjian, Canton, MI (US)

(21) Appl. No.: 19/172,745

(22) Filed: Apr. 8, 2025

(51) Int. Cl. H01M 10/658; H01M 10/625; H01M 50/249; H01M 50/262; H01M 50/291; H01M 50/211

(52) U.S. Cl. CPC H01M 10/658; H01M 10/625; H01M 50/249; H01M 50/262; H01M 50/291; H01M 50/211; H01M 2220/20

(57) ABSTRACT

A traction battery pack assembly includes first and second thermal barriers each having a divider section and a covering section, and one or more battery cells sandwiched between the divider section of the first thermal barrier and the divider section of the second thermal barrier along a cell stack axis. The covering section of the first thermal barrier extends axially over at least a portion of the one or more battery cells and interfaces with the covering section of the second thermal barrier through a tongue-and-groove interface.

### TECHNICAL FIELD

This disclosure relates generally to thermal barriers of a battery pack and, more particularly, to how the thermal barriers interface with each other within the battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

In some aspects, the techniques described herein relate to a traction battery pack assembly, including: first and second thermal barriers each having a divider section and a covering section; and one or more battery cells sandwiched between the divider section of the first thermal barrier and the divider section of the second thermal barrier along a cell stack axis, the covering section of the first thermal barrier extending axially over at least a portion of the one or more battery cells and interfacing with the covering section of the second thermal barrier through a tongue-and-groove interface.

In some aspects, the techniques described herein relate to a traction battery pack assembly, wherein the covering section of the first thermal barrier includes a tongue that is received in a groove provided within the covering section of the second thermal barrier.

In some aspects, the techniques described herein relate to a traction battery pack assembly, wherein the groove opens in a direction that is parallel to the cell stack axis.

In some aspects, the techniques described herein relate to a traction battery pack assembly, wherein the tongue is configured move axially within the groove in response to expansion of the one or more battery cells along the cell stack axis.

In some aspects, the techniques described herein relate to a traction battery pack assembly, wherein the tongue is configured to be snap-fit within the groove.

In some aspects, the techniques described herein relate to a traction battery pack assembly, wherein the tongue includes an enlarged tip.

In some aspects, the techniques described herein relate to a traction battery pack assembly, wherein the groove is a T-slot configured to capture the enlarged tip to resist withdrawal of the enlarged tip from within the groove.

In some aspects, the techniques described herein relate to a traction battery pack assembly, wherein the groove includes a narrowed area at an open end of the groove, wherein a width of the narrowed area is less than a width of the enlarged tip such that covering section flexes to accommodate the enlarged tip as the tongue is inserted into the groove.

In some aspects, the techniques described herein relate to a traction battery pack assembly, wherein the covering section of at least one of the first or the second thermal barriers provides a channel to accommodate electrical components of the battery pack.

In some aspects, the techniques described herein relate to a traction battery pack assembly, wherein the channel opens in a direction transverse to the cell stack axis.

In some aspects, the techniques described herein relate to a traction battery pack assembly, wherein the channel opens upward.

In some aspects, the techniques described herein relate to a traction battery pack assembly, further including adhesively bonding the first thermal barrier to an enclosure of a traction battery pack.

In some aspects, the techniques described herein relate to a traction battery pack assembly, wherein the covering section of the first thermal barrier and the covering section of the second thermal barrier each include a stand-off that extends to contact the enclosure.

In some aspects, the techniques described herein relate to a traction battery pack assembly, wherein the stand-off of the first thermal barrier is offset along the cell stack axis from the divider section of the first thermal barrier, wherein the stand-off of the second thermal barrier is offset along the cell stack axis from the divider section of the second thermal barrier.

In some aspects, the techniques described herein relate to a traction battery pack assembly, wherein the covering section of at least one of the first or the second thermal barriers provides a channel to accommodate electrical components of the battery pack.

In some aspects, the techniques described herein relate to a traction battery pack assembly, including: first and second thermal barriers each having a T-shaped cross-section with a stem section and a T-top section; and one or more battery cells sandwiched between the stem section of the first thermal battery and the stem section of the second thermal barrier along a cell stack axis, the T-top section of the first thermal barrier extending axially over at least a portion of the one or more battery cells in a first axial direction, the T-top section of the second thermal barrier extending axially over at least a portion of the one or more battery cells in a second axial direction to interlock with the T-top section of the first thermal barrier.

In some aspects, the techniques described herein relate to a traction battery assembly, wherein the interlock is provided by a tongue and groove connection.

In some aspects, the techniques described herein relate to a traction battery assembly, wherein the T-top section of the first thermal barrier horizontally overlaps the T-top section of the second thermal barrier, wherein the T-top section of the first thermal barrier vertically overlaps the T-top section of the second thermal barrier.

In some aspects, the techniques described herein relate to a traction battery pack assembly, including: first and second thermal barriers each having a divider section and a covering section, the divider section of the first thermal barrier and the divider section of the second thermal barrier configured to sandwich one or more battery cells along a cell stack axis, the covering section of the first thermal barrier configured to extend axially over at least a portion of the one or more battery cells to interface with the covering section of the second thermal barrier through a tongue-and-groove interface.

In some aspects, the techniques described herein relate to a traction battery assembly comprising the one or more battery cells sandwiched between the divider section of the first thermal barrier and the divider section of the second thermal barrier along the cell stack axis.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a perspective view of a battery array from the electrified vehicle of FIG. 1.

FIG. 3 illustrates a section view taken at line 4–4 in FIG. 2 and showing a cell stack of the battery array within an enclosure assembly of the battery array.

FIG. 4 illustrates a perspective view of a thermal barrier from the cell stack of the FIG. 3 according to an exemplary aspect of the present disclosure.

FIG. 5 is a close-up view of an area of FIG. 3 showing thermal barriers of the battery pack according to an exemplary embodiment of the present disclosure.

FIG. 5A is the area of FIG. 3 showing thermal barriers according to another exemplary embodiment of the present disclosure.

### DETAILED DESCRIPTION

This disclosure details exemplary traction battery packs with cell stacks having thermal barriers that interface within each other through interlocking interfaces. The thermal barrier can be bonded to an enclosure structure and can block vent byproducts emitted from battery cells from impinging directly on the enclosure structure.

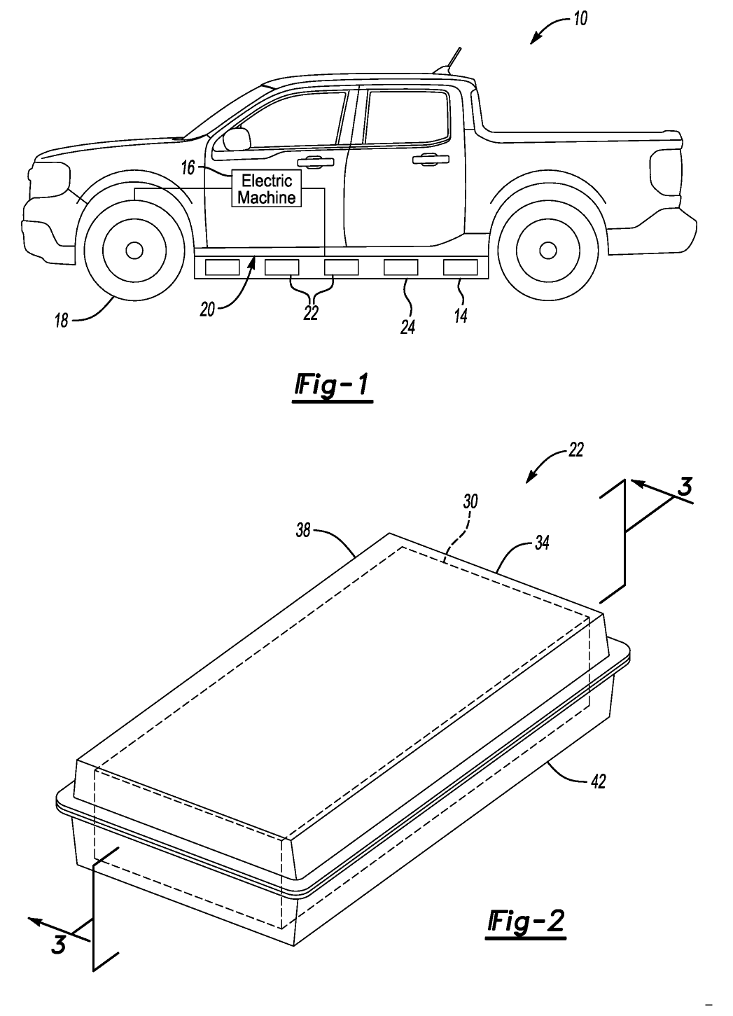

With reference to FIG. 1, an electrified vehicle 10 includes a battery pack 14, an electric machine 16, and wheels 18. The battery pack 14 powers the electric machine 16, which can convert electrical power to mechanical power to drive the wheels 18. The battery pack 14 is thus a traction battery pack.

The battery pack 14 is, in the exemplary embodiment, secured to an underbody 20 of the electrified vehicle 10. The battery pack 14 could be located elsewhere on the electrified vehicle 10 in other examples. In the exemplary embodiment, the traction battery pack 14 includes one or more battery arrays 22 housed within a pack enclosure 24.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

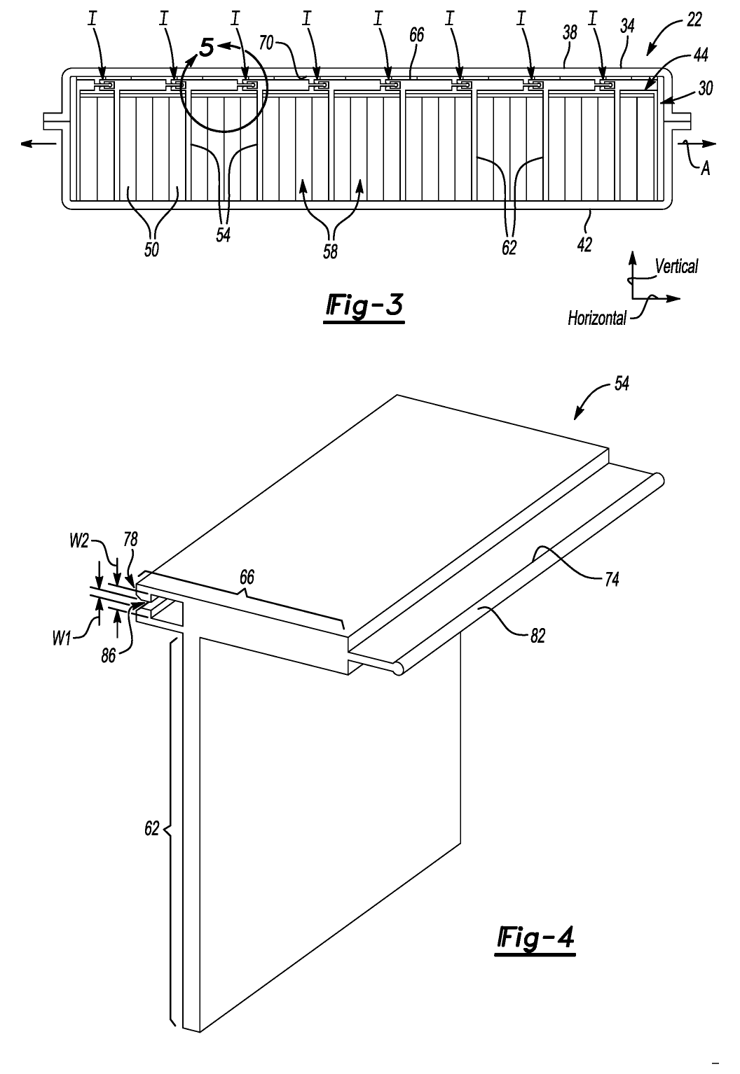

With reference now to FIGS. 2–4 and continuing reference to FIG. 1, the arrays 22 within the pack enclosure 24 each include one or more cell stacks 30 held within an enclosure assembly 34, which, in the exemplary embodiment, includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) and one or more thermal barriers 54 disposed along a respective cell stack axis A. The battery cells 50 store and supply electrical power. The battery pack 14 could include any number of the cell stacks 30 each having any number of individual cells 50. The single cell stack 30 and its thirty-two cells 50 are an example.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure. With the cell stacks 30, the individual battery cells 50 can be electrically connected together.

The battery cells 50 are arranged in groups 58, which are separated from each other along the axis A by the thermal barriers 54. In this example, the battery pack 14 includes seven groups 58 of four battery cells 50, and two groups 58 of two battery cells 50.

The thermal barriers 54 each have a divider section 62 and a covering section 66. In this example, the divider sections 62 and the covering sections 66 project outward from the cell stack axis past the groups 58 of battery cells 50. In some examples, other dividers without covering sections can be disposed between the individual battery cells 50. The dividers without covering sections could be multi-layered structures including a mica layer sandwiched between foam layers.

The divider sections 62 are vertically aligned and are the portions of the thermal barriers 54 that are between the battery cells 50 along the cell stack axis A. The groups 58 of four battery cells 50 are each sandwiched between the divider sections 62 of two thermal barriers 54. Vertical and horizontal, for purposes of this disclosure are with reference to ground and a general orientation of the battery pack 14 when installed with the electrified vehicle 10.

The covering sections 66 of the exemplary embodiment extend horizontally from a vertical upper portion of the divider sections 62, which gives the thermal barriers 54 a T-shaped cross-sectional profile. The covering sections 66 can be considered to provide a T-top section of the T-shape while the divider sections 62 a stem section of the T-shape.

The covering sections 66 are spaced vertically a distance D from the battery cells 50. The covering sections 66 can extend horizontally toward the covering section 66 of an axially adjacent thermal barrier 54. The covering sections 66 of axially adjacent thermal barriers 54 meet at interfaces I.

The thermal barriers 54 can help to compartmentalize the interior area 44. If, for example, one of the battery cells 50 undergoes a thermal event and begins to discharge vent byproducts, the vent byproducts can be discharged vertically upward through a ruptured area R of the battery cell 50 or through a defined vent. The thermal barriers 54 block those vent byproducts from moving axially adjacent to another groups 58 of battery cells 50 and block those vent byproducts from moving upward to impinge on an underside 70 of the enclosure cover 38.

At each interface I, the covering section 66 of one thermal barrier 54 overlaps with the covering section 66 of the thermal barrier 54. That is, the covering section 66 of a first one of the thermal barriers 54 extends axially in a first direction over one of the groups 58, and the covering section 66 of a second of the thermal barriers 54 extends axially in an opposite, section direction to at least partially axially overlap with a portion of the covering section 66 of the first one of the thermal barriers 54.

The example thermal barriers 54 interlock with each other when installed. In particular, the covering sections 66 of the example thermal barriers 54 interface with each other through a tongue-and-groove interface. Other example thermal barriers could interlock with each other in other ways.

The covering sections 66 of the example thermal barriers 54 include a tongue 74 on a first axial side and a groove 78 on an opposite axial side. When the thermal barriers 54 are installed, the tongue 74 of one of the thermal barriers 54 is received within the groove 78 of the axially adjacent thermal barrier 54. The groove 78 opens in a direction that is parallel to the cell stack axis A in this example.

In this example, the tongue 74 includes an enlarged tip 82. The groove 78 is a T-slot configured to capture the enlarged tip 82 and snap-fit the tongue 74 within the groove 78. The groove 78 includes a narrowed area 86 at an open end of the groove 78. A width W1 of the narrowed area 86 of the groove 78 is less than a width W2 of the enlarged tip 82. During installation, as the tongue 74 is inserted into the groove 78, the portions of the thermal barrier 54 providing the groove 78 can flex to accommodate the enlarged tip 82 and allow the tongue 74 to move into the groove 78. After the enlarged tip 82 passes through the narrowed area 86, the portions of the thermal barrier 54 providing the groove 78 can flex back to capture the enlarged tip 82 within the groove 78 and resist withdrawal of the tongue 74 from the groove 78.

Over time, one or more of the battery cells 50 can expand and push axially against the thermal barriers 54. Should this cause the thermal barriers 54 that are interlocked to move axially relative to each other, the tongue 74 can slide a bit axially within the groove 78 in response to expansion of the one or more battery cells 50. That is, the example tongue-and-groove interlock can accommodate some relative axial movement of the thermal barriers 54. Making the groove 78 a bit oversized allows the tongue 74 and groove 78 to move axially relative to each other while remaining interlocked, which help to accommodate assembly variation.

The example thermal barriers 54 can be pultruded or extruded thermal barriers. A person having skill in this art would be able to structurally distinguish a pultruded thermal barrier or extruded thermal barrier from another type of thermal barrier, such as a thermal barrier that is molded. Thus, specifying that the thermal barrier is a pultruded or extruded thermal barrier imparts structural characteristics to the thermal barrier 54, such as fiber orientation, material composition, and mechanical properties.

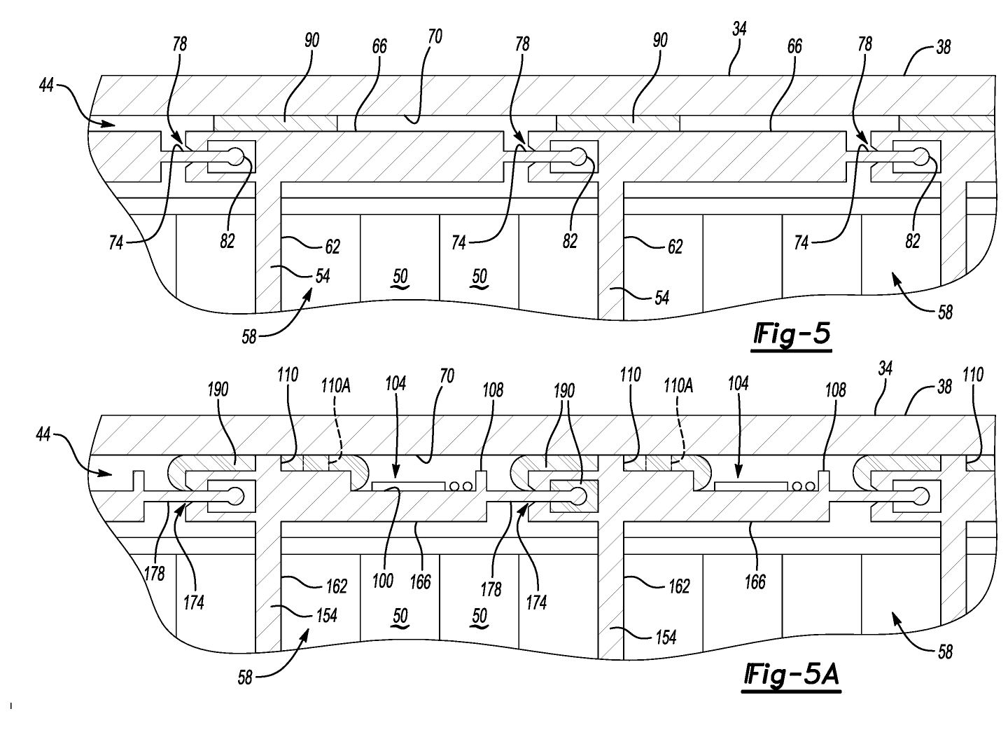

In the example of FIG. 5, an adhesive 90 bonds the thermal barriers 54 to the underside 70 of the enclosure cover 38. With reference to FIG. 5A, thermal barriers 154 according to another exemplary aspect of the present disclosure, include a channel 100 within a covering section 166. The channel 100 opens vertically upward in a direction transversed to an axis of the cell stack. Electrical components 104 such as wiring and circuit boards, can be housed within the channel 100.

A rib 108 extends up from the covering section 166 and can be used to provide a wall of the channel 100. Some of the adhesive 190 applied to bonds the covering section 166 to the underside 70 of the enclosure cover 38 can be redirected by the rib 108 into a groove 178 of the thermal barrier 154 to help join a tongue 174 of an axially adjacent thermal barrier 154 within the groove 178. The groove 178 can hold the adhesive 190 and act as a trap to prevent the adhesive 190 from dripping on top of the cells 50.

The thermal barriers 154 can optionally include a stand-off 110 extending upward from the covering section 166 to contact the underside 70 of the enclosure cover 38. The stand-off 110 can provide a hard interface between the thermal barriers 154 and the enclosure cover 38 to control a thickness of the adhesive 190 and to provide a positive stop during assembly.

In some examples, the stand-off 110 can be shifted axially closer to the channel 100 as shown in by broken lines 110A in FIG. 5A. Shifting the stand-off 110 to be offset relative to the divider sections 162 of the thermal barriers 154 can provide more area for accommodating the adhesive 190 while blocking the adhesive 190 from flowing into the channel 100.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
first and second thermal barriers each having a divider section and a covering section; and
one or more battery cells sandwiched between the divider section of the first thermal barrier and the divider section of the second thermal barrier along a cell stack axis, the covering section of the first thermal barrier extending axially over at least a portion of the one or more battery cells and interfacing with the covering section of the second thermal barrier through a tongue-and-groove interface.

2. The traction battery pack assembly of claim 1, wherein the covering section of the first thermal barrier includes a tongue that is received in a groove provided within the covering section of the second thermal barrier.

3. The traction battery pack assembly of claim 2, wherein the groove opens in a direction that is parallel to the cell stack axis.

4. The traction battery pack assembly of claim 2, wherein the tongue is configured move axially within the groove in response to expansion of the one or more battery cells along the cell stack axis.

5. The traction battery pack assembly of claim 2, wherein the tongue is configured to be snap-fit within the groove.

6. The traction battery pack assembly of claim 5, wherein the tongue includes an enlarged tip.

7. The traction battery pack assembly of claim 6, wherein the groove is a T-slot configured to capture the enlarged tip to resist withdrawal of the enlarged tip from within the groove.

8. The traction battery pack assembly of claim 6, wherein the groove includes a narrowed area at an open end of the groove, wherein a width of the narrowed area is less than a width of the enlarged tip such that covering section flexes to accommodate the enlarged tip as the tongue is inserted into the groove.

9. The traction battery pack assembly of claim 8, wherein the covering section of at least one of the first or the second thermal barriers provides a channel to accommodate electrical components of the battery pack.

10. The traction battery pack assembly of claim 9, wherein the channel opens in a direction transverse to the cell stack axis.

11. The traction battery pack assembly of claim 10, wherein the channel opens upward.

12. The traction battery pack assembly of claim 1, further comprising adhesively bonding the first thermal barrier to an enclosure of a traction battery pack.

13. The traction battery pack assembly of claim 12, wherein the covering section of the first thermal barrier and the covering section of the second thermal barrier each include a stand-off that extends to contact the enclosure.

14. The traction battery pack assembly of claim 13, wherein the stand-off of the first thermal barrier is offset along the cell stack axis from the divider section of the first thermal barrier, wherein the stand-off of the second thermal barrier is offset along the cell stack axis from the divider section of the second thermal barrier.

15. The traction battery pack assembly of claim 1, wherein the covering section of at least one of the first or the second thermal barriers provides a channel to accommodate electrical components of the battery pack.

16. A traction battery pack assembly, comprising:
first and second thermal barriers each having a T-shaped cross-section with a stem section and a T-top section; and
one or more battery cells sandwiched between the stem section of the first thermal battery and the stem section of the second thermal barrier along a cell stack axis, the T-top section of the first thermal barrier extending axially over at least a portion of the one or more battery cells in a first axial direction, the T-top section of the second thermal barrier extending axially over at least a portion of the one or more battery cells in a second axial direction to interlock with the T-top section of the first thermal barrier.

17. The traction battery assembly of claim 16, wherein the interlock is provided by a tongue and groove connection.

18. The traction battery assembly of claim 16, wherein the T-top section of the first thermal barrier horizontally overlaps the T-top section of the second thermal barrier, wherein the T-top section of the first thermal barrier vertically overlaps the T-top section of the second thermal barrier.

19. A traction battery pack assembly, comprising:
first and second thermal barriers each having a divider section and a covering section, the divider section of the first thermal barrier and the divider section of the second thermal barrier configured to sandwich one or more battery cells along a cell stack axis, the covering section of the first thermal barrier configured to extend axially over at least a portion of the one or more battery cells to interface with the covering section of the second thermal barrier through a tongue-and-groove interface.

20. The traction battery pack assembly of claim 19, further comprising the one or more battery cells sandwiched between the divider section of the first thermal barrier and the divider section of the second thermal barrier along the cell stack axis.
